(19) United States
(12) Patent Application Publication
(10) Pub. No.: US 2008/0053084 A1
(43) Pub. Date: Mar. 6, 2008

(54) Method and Apparatus for Utilising Wave Energy

(76) Inventors: Peter Kenneth Stansby, Cheshire (GB); Alan Charles Williamson, Manchester (GB); Nicholas Jenkins, Cheshire (GB)

Correspondence Address: Monique A Morneault;WALLENSTEIN WAGNER & ROCKEY LTD, 311 South Wacker Drive 5300, Chicago, IL, 60606, US

(21) Appl. No.: 10/575,317

(22) PCT Filed: Oct. 15, 2004
(86) PCT No.: PCT/GB04/04393

§ 371 Date: May 10, 2007

(30) Foreign Application Priority Data
Oct. 16, 2003 (GB) 0324183.3

(51) Int. Cl. F03B 13/18

(52) U.S. Cl. 60/501

(57) ABSTRACT

Apparatus for extracting energy from waves comprises a float device coupled to a shaft such that vertical movement of the float devices drives the shaft. Movement of the float device is generated by the wave motion, and the mass of the float device is such that its natural frequency of vertical oscillation is substantially resonant with the frequency of a sea wave. The mass of the float device can be adjustable to achieve this.

This invention relates to methods and devices for utilising wave energy, in particular for converting the motion of sea waves into a source of useful power output.

There have been many attempts to harness the energy involved in wave motion of water. Usually, the object of such systems is to convert the wave motion of water into electricity. Many prior art systems are structurally complicated in nature and characterised by operating efficiencies which are somewhat less than would be desirable. Probably of most relevance to the present invention are U.S. Pat. No. 4,379,235 and U.S. Pat. No. 5,424,582, the contents of which are hereby incorporated herein by reference, which describe wave power generators which comprise a flywheel in operative connection to electricity generating means, the flywheel being driven by the motion of a float which follows the rising and falling portions of passing waves.

The present invention provides improved methods and devices for utilising wave energy which may be structurally quite simple in nature and which can operate with relatively high efficiency. For the avoidance of doubt, the term “sea wave” as used herein, refers to any naturally occurring wave present on a body of water such as a sea, ocean or even a tidal wave or bore occurring on a river.

According to a first aspect of the invention there is provided apparatus for converting the motion of sea waves into a source of useful power output, the apparatus comprising:

a structure having a drive shaft mounted thereon;

a float device connected to said structure and in operative connection with the drive shaft so that vertical motion of the float device drives the drive shaft; and

a rotatable device in operative connection with the drive shaft so that rotation of the drive shaft rotates the rotatable device;

in which the float device has a natural frequency of vertical oscillation which is substantially resonant with the frequency of a sea wave.

The apparatus may include a counterweight in operative connection with the float device. In this arrangement it is the natural frequency of the combination of the float device and counterweight that is made substantially resonant with the frequency of the sea wave.

The mass of the float device may be adjustable so as to tune the natural frequency of vertical oscillation of the float device to be substantially resonant with the frequency of a sea wave. Operational adjustment of the mass of the float device may be achieved by providing the float device with an interior chamber and means for admitting water into the chamber and/or expelling water from the chamber. Alternatively, the natural frequency may be tuned by adding or removing other weights from the float device, or by changing the shape of the float device. In this way, the operation of the device can be optimised with respect to the current—or predicted—wave conditions.

Advantageously, the rotatable device comprises electricity generating means. Additionally, a flywheel can be employed to provide further inertia. Alternatively, it is possible to use a simple flywheel as the rotatable device to act as a store of energy available to perform other operations, such as mechanical operations.

In a preferred embodiment, the device further comprises clutch means, said clutch means being disposed with respect to the rotatable device so that the rotatable device is rotated by the drive shaft in only one direction. The predetermined direction may correspond to the rising portion of a wave or the falling portion of a wave. A switching device may be included to drive the rotatable device in both directions of movement of the float device.

The device may further comprise constraining means adapted to restrict side to side motion of the float device. The constraining means may comprise tethers, or any other suitable means.

Advantageously, the device further comprises at least one gearing system for controlling the transmission of rotational motion to or from the rotatable device. The gearing system may be disposed between the drive shaft and the rotatable device and/or after the rotatable device. In embodiments comprising clutch means, the gearing system may be disposed between the drive shaft and the clutch means and/or between the clutch means and the rotatable device.

The float device may be connected to said structure via a device disposed below the level of the float device so that the float device drives the drive shaft during the rising portion of a wave. The device may comprise a pulley, spindle or like device.

The float device may have a natural frequency which is substantially resonant with the frequency of a sea wave of wave height in the range 0.5 to 10 m, preferably in the range 1.0 to 4.0 m, most preferably about 2.0 m. The wave height is defined as being the vertical distance between the peak and trough of a wave.

The natural frequency of oscillation of the float device may be in the range 0.05 to 0.33 Hz, corresponding to dominant periods in the range 3 to 20 s.

The mass of the float device may be in the range 50 to 10,000 tonnes.

The device may be adapted so that, when the natural frequency of vertical oscillation of the float device is substantially resonant with the frequency of a sea wave, the amplitude of oscillation of the float device is magnified due to resonance. The amplitude of oscillation of the float device may exceed the amplitude of oscillation of the sea wave, preferably exceeding the amplitude of oscillation of the sea wave by a factor of two or more. By amplitude of oscillation is meant the extent of the motion (of a wave or of the float device) from the origin of the oscillatory motion. In other words, the amplitude of oscillation of a sea wave is one half of the corresponding sea wave height.

The device may comprise a substantially rigid connecting rod coupled to the float device and permitting the float device to be connected to said structure. This arrangement avoids problems associated with flexing of the component used to suspend the float device. In related embodiments, the device further comprises a crank arm, the connecting rod being in operative connection with the drive shaft via the crank arm. The device may further comprise a counterbalance arm. The device may still further comprise a pivot, in which: the crank arm and the counterbalance are in connection with the pivot so that movement of the connecting rod causes rotational motion of the counterbalance arm about the pivot; and the counterbalance arm is in operative connection with the drive shaft so that rotational motion of the counterbalance arm about the pivot rotates the rotatable device. This enables the connecting rod to be always in tension and hence in a known state. Additionally, this arrangement permits the addition of inertia to the system which can be used to modify the natural frequency. In any of the embodiments comprising a substantially rigid connecting rod, at least one gearing system may be used to control the transmission of rotational motion to or from the rotatable device. The gearing system may be disposed between the connecting rod and the drive shaft.

According to a second aspect of the invention there is provided a method of converting the motion of sea waves into a source of useful power output comprising the steps of:

disposing a float device on a body of water so that the float device floats thereon;

allowing the motion of sea waves across the body of water to vertically displace the float device; and

transmitting power associated with vertical displacement of the float device to a rotatable device so that the vertical displacement of the float device caused by the motion of the sea waves rotates the rotatable device;

in which the natural frequency of vertical oscillation of the float device and any counterbalance weight used, is substantially resonant with the frequency of the sea waves.

The wave height of the sea waves may be in the range 0.5 to 10 m, preferably in the range 1.0 to 4.0 m, most preferably about 2.0 m.

The natural frequency of vertical oscillation of the float device may be in the range 0.05 to 0.33 Hz.

The amplitude of oscillation of the float device may exceed the amplitude of oscillation of the sea wave, preferably exceeding the amplitude of oscillation of the sea wave by a factor of two or more.

The method may further comprise the step of generating electricity from the rotation of the rotating device. In this instance power associated with vertical displacement of the float device may be transmitted also to a flywheel. In this way, the moment of inertia of the rotatable device can be augmented.

In other embodiments, the rotatable device may comprise a flywheel.

The method may comprise the further step of adjusting the mass of the float device and/or a counterbalance weight operatively connected therewith so as to tune the natural frequency of vertical oscillation of the float device to be substantially resonant with the frequency of the sea waves.

Power may be transmitted to the rotatable device through clutch means so that the rotatable device is rotated only when the float device is vertically displaced in a predetermined direction.

Methods and devices in accordance with the invention will now be described with reference to the accompanying drawings, in which:

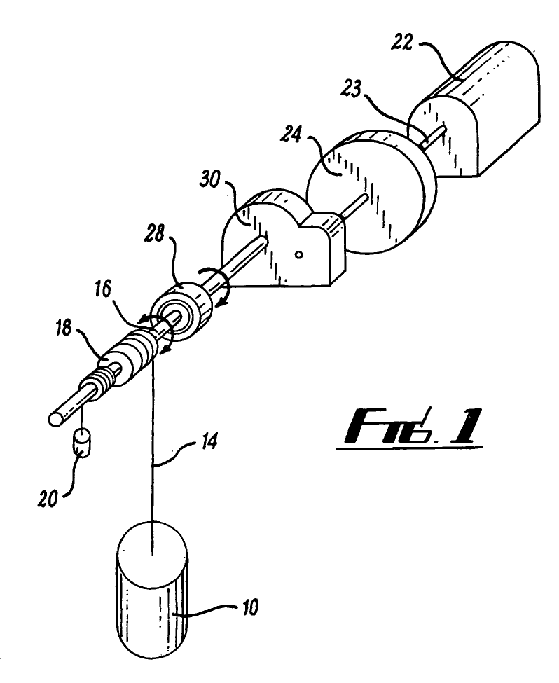

FIG. 1 shows schematically a first embodiment of a device for converting the motion of sea waves into a source of electricity;

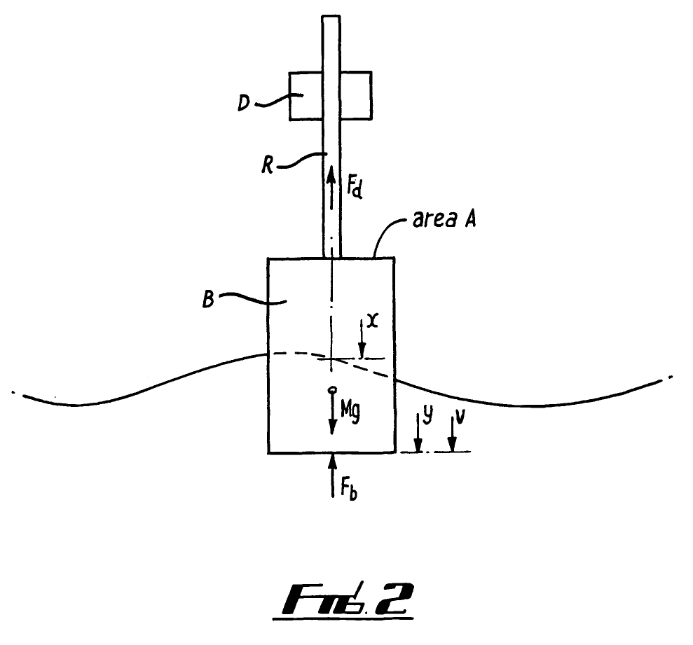

FIG. 2 shows a system including a float device used for mathematical modelling;

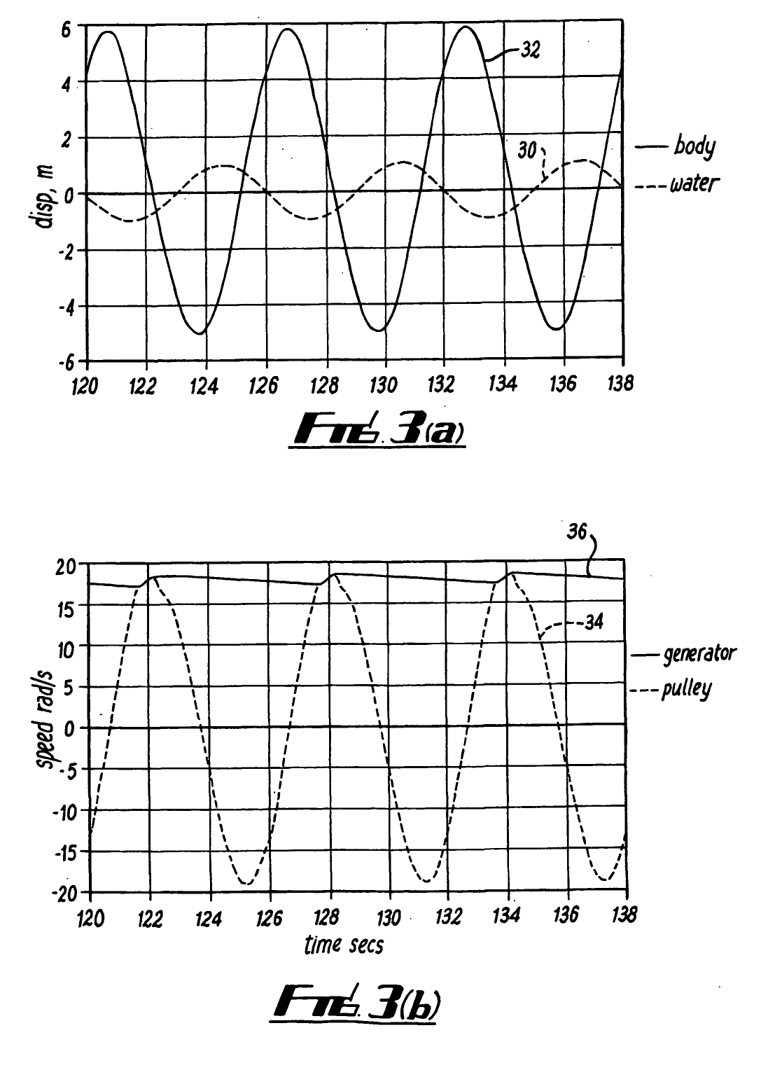

FIG. 3 shows (a) displacement of water and float device and (b) speeds of the pulley and generator obtained by simulation of the behaviour of the system described by FIGS. 1 and 2; and

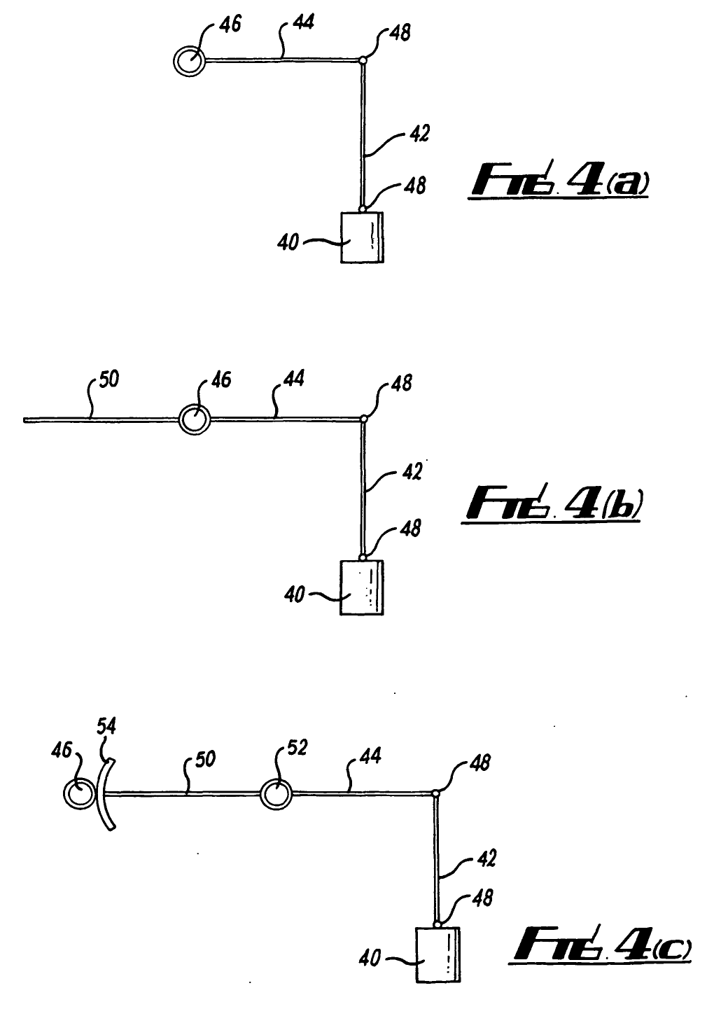

FIG. 4 shows (a) a second embodiment, (b) a third embodiment and (c) a fourth embodiment of portions of a device for converting the motion of sea waves into a source of electricity.

The present invention provides a means of harnessing the energy involved in wave motion of water. The invention can utilise a comparatively simple arrangement which minimises the structure and hardware needed to couple the motion of the water to a rotating shaft to produce continuous generation of electricity or, if preferred, mechanical power output. The device is suited to offshore conditions where the availability of wave power is high, as well as nearshore conditions where conditions are less extreme.

The present invention is based around a body which has sufficient buoyancy to follow the rise and fall of the surface of the water. An important feature of this device is that advantage is taken of the natural frequency of such a buoyant body in amplifying the vertical motion of the body when the wave frequency is close to the natural frequency of the body. The device may thus be tuned to the most probable wave frequency. Typically, but not exclusively, the device is tuned so that its natural frequency coincides with relatively small wave heights for which amplification is most desirable. The body may be connected to a structure which is fixed to the ground (as in shore-based, or nearshore-based implementations) or to a platform which is supported either from the seabed or by floats (as in offshore implementations).

In a first embodiment of the invention, depicted in FIG. 1, the body 10 is suspended from a structure (not shown) by a suspending component 14 such as a cable, wire, rope or similarly flexible component. The body 10 is adapted to rise and fall with the movement of the water, but does not have to be in contact with or submerged in the water at all times. The supporting structure can be any suitable body, such as a platform. The suspending component 14 is taken over and transmits motion to a drive shaft 16 via a pulley 18. As the body 10 rises a counterweight 20 takes in the slack in the suspending component 14 by rotating the pulley 18. A drive mechanism might be employed instead for this purpose. The drive shaft 16 is connected to an electricity generator 22 through a clutch/freewheel device 28 and gearbox 30. The clutch 28 is caused to engage and disengage the connection of the drive shaft 16 with an electricity generator 22 by means of a ratcheting/freewheel device. Thus, the clutch/freewheel 28 allows the electricity generator 22 to rotate in the direction opposite to that of the pulley 18 as the body 10 rises. The gearbox increases the rotational speed of the shaft, typically by a ratio of 20:1, but the ratio can be selected for each site of application. A separate flywheel 24, on the shaft 23 between the gearbox 30 and the generator 22, provides extra inertia coupled to the generator 22. At the peak of a wave, the body 10 starts to descend under the action of gravity, and the pulley 18 begins to rotate in the same direction as the electricity generator 22. At some time during the fall of the body 10 the speed of the pulley 18, which is enhanced by resonance, becomes equal to that of the electricity generator 22 and, under these conditions, the freewheel device 28 engages so that the increasing downwards velocity of the body 10 causes the speed of the electricity generator 22 to increase. When the body 10 ceases its downward acceleration as a result of interaction with the water surface 26 the freewheel device 28 is disengaged, allowing the flywheel 24 and electricity generator 22 to continue their rotation as the pulley 18 decelerates to zero speed. The cycle then commences to repeat as the water surface 26 rises and starts to lift the body 10. If the electricity generator 22 and the flywheel 24 are together designed with sufficient moment of inertia, then useful power may be extracted during the entire cycle with the speed of the electricity generator 22 falling during the interludes between the acceleration periods, but remaining high enough to keep the generating capability through the cycle.

By using the gearbox 30 to increase the speeds of the generator 22 and flywheel 24, for example to speeds in excess of 1000 rev/min, the size of both generator 22 and flywheel 24 can be reduced for a given energy extraction per cycle. The freewheel device can be placed either between pulley and gearbox, or between gearbox and generator and flywheel. Although not essential for the operation of the system, a preferred refinement involves the attachment of tethers to the body 10 to restrict motion within a horizontal plane. The tethers, preferably at least three in number, allow the body 10 to rise and fall under the action of the largest waves, yet constrain its position sufficiently to permit optimal operation of the pulley 18. Other motion constraining systems might be envisaged.

In a second embodiment of the invention the flywheel is dispensed with. Thus, the drive shaft solely drives the electricity generator and not an additional flywheel. Again, appropriate gearing can be employed.

An important aspect of the invention concerns resonance. To illustrate the effects of resonance the system will be reduced in complexity by making certain assumptions. The reduced system is shown in FIG. 2. Here a floating body B is shown, for the purpose of illustration, as a right cylinder of cross-sectional area A, and is attached, for the purpose of illustration, to a rigid rod R which passes through an energy absorbing device D. The device D extracts energy by the production of a force F_{d} which opposes the motion of the rod R. Again, for the purpose of illustration the force is assumed to be proportional to the velocity v of the rod and body.

The buoyancy force acting will depend upon the immersion. For the assumptions made in this illustration, the force is given by

F_{b}=Aσg(y−x)

Where σ is the density of the water, g is the acceleration of gravity, x is the fall of the water surface from a datum and y is the fall of the buoy from the same datum. It will be noted that this can be written as:

F_{b}=k_{b}(y−x)
where k_{b}=Aσg is a constant.

The force F_{d} can be written as

F_{d}=k_{d}v
where k_{d} is also a constant under the assumptions made here.

In this simplification, k_{d} accounts for the energy extraction by the device D but there is also energy extraction due to the motion of the body B relative to the water body causing damping. This takes the form of frictional resistance and also radiation damping due to waves being radiated from the body. The former may be minimised by streamlining the body and the latter tends to zero as the body cross-sectional area tends to zero. The shape of the body can be optimised for energy extraction in resonant conditions.

The buoy is thus acted upon by three forces in the vertical direction, the weight Mg and the two forces F_{d} and F_{b}.

Under static conditions with x=0 and v=0, the value of y=yₒ and Mg=k_{b}yₒ.

If a quantity z is defined as (y−yₒ) then the motion of the buoy as a function of time t is defined by the differential equation:

$$M \frac{{d}^{2} z}{{dt}^{2}} + {k}_{d} \frac{d z}{d t} + {k}_{b} z = {k}_{b} x$$

If the water surface fall is defined by

x=W sin(ωt) where W=half the wave height and the wave period T=2π/ω then the solution to the equation is: z=A sin(ωt−φ)

$$A = \frac{{ω}_{0}^{2} W}{\sqrt{{( {ω}_{0}^{2} - {ω}^{2} )}^{2} + {( {k}_{d} ω / M )}^{2}}}$$

where
and

ω₀²=k_{b}/M.

$$tan ( φ ) = \frac{{k}_{d} ω / M}{( {ω}_{0}^{2} - {ω}^{2} )}$$

The parameter ωₒ is the undamped natural frequency of the system.

The rate of extraction of energy from the system is given by the product F_{d} and v and it can be shown that the average power extracted over a cycle is given by:

P=0.5 k_{d}ω²A²

Resonance occurs when the exciting frequency ω is the same as the undamped natural frequency ωₒ. In this case, for a given wave height, the amplitude of the oscillation of the buoy is a maximum and could even be greater than W, the amplitude of the wave.

One aspect of the invention lies in the adjustment of the system parameters to satisfy conditions for resonance. The values of k_{b} and M can be adjusted in the design of the system to make the system resonant frequency suit a chosen value of wave period to achieve large values of oscillation amplitude.

The above is somewhat of a simplification for the purposes of demonstration. In practice, a system is nonlinear in at least two respects. One has been mentioned above in relation to hydrodynamic damping due to relative motion between the body and the water body. As the body oscillates in the water the damping force will only be proportional to velocity for small amplitudes. In general for larger amplitudes nonlinearities in many physical systems reduce this effect. Another aspect is that, by the nature of the device, useful energy may only be extracted during parts of the cycle of oscillation. The latter factor in particular makes it impossible to solve for the motion of the system analytically. However, it is possible to simulate numerically, and this has been done for one particular set of conditions, while maintaining the linear friction assumption.

FIG. 3 shows the steady state behaviour of a floating body of the type shown in FIG. 2 when excited by a wave motion of period 6 s and wave height 2 m. These are considered to represent relatively calm conditions in most large seas or oceans. The body, of mass 300 Tonnes, is supported by a cable pulling over a pulley of diameter 0.6 m. The pulley is connected through a ratcheting freewheel to a generator having an efficiency of 80% which provides a smooth unvarying output of 0.3 MW. A friction coefficient of 0.02 is assumed on the body surface and the body is assumed to be of sufficiently small cross section for negligible radiation damping.

FIG. 3(a) shows the displacements of water 30 and body 32, and these clearly demonstrate the amplification of oscillation amplitude by resonance. Amplifications of nearly six times are shown in FIG. 3(a). In FIG. 3(b) the speeds of pulley 34 and generator 36 are shown. It can be seen how the oscillating speed of the pulley is mechanically rectified to give a unidirectional speed of the generator.

The parameters utilised in the system simulated for the purposes of FIG. 3 are illustrative, and may be varied in a number of ways. For example, in the system above a right cylinder is convenient for demonstration because it gives a constant factor k_{b}. The minimisation of frictional resistance and radiation damping have been mentioned above, and indeed a right cylinder is not ideal in respect of the former consideration. However the shape of the body may also control the oscillation. Thus, the performance of the system can be varied by way of varying the shape of the floating body. The dimensions of the floating body can also be varied so as to control the performance of the system. For example it is possible to limit the amplitude of oscillation by choice of overall height of the body. In preferred, but non-limiting, examples, the natural frequency of oscillation of the float device is in the range 0.05 to 0.33 Hz, and the mass of the float device is in the range 50 to 10,000 tonnes, preferably 100 to 100 tonnes. The float device may comprise reinforced concrete, although other materials might be employed.

Should wave conditions change, it may be desirable that the natural frequency of the body also be changed. In a preferred but not limiting example the mass of the body is conveniently increased by admitting water into its interior by releasing one-way hatches at the required level. These would admit water during immersion but retain water when emerging. To reverse the process and to reduce the mass, water could be shed by suitable reverse acting one-way hatches, or scuppers, which allow egress of water from the body on emerging but prevent ingress during immersion. Of course any other method of adding and shedding mass—not necessarily water—could achieve the same objective.

In one mode of operating devices of the present invention, the device is tuned so as to be resonant with relatively small waves of wave height around 2 m. The device might be retuned so as to be resonant with slightly different waves should sea conditions change somewhat. However, the device is not tuned to be resonant with large waves if such waves (eg, waves of wave height around 10 m or greater) are encountered, because such waves supply a great deal of power even to an untuned device.

A further alternative embodiment of the invention uses the same essential principles as discussed above, but also places a pulley, spindle or like device under the water surface. The suspending component, as well as passing over an upper pulley also passes under a lower pulley before being connected to the body. By such means the generator is accelerated during the upward motion of the body. The advantage of such a system is that it will be possible to produce, by means of buoyancy, increased accelerating forces at the pulley for a given mass of the body.

FIG. 4 shows a number of alternative drive systems which are within the scope of the invention. For simplicity of presentation, FIG. 4 depicts the mechanical linkages between the float device and the drive shaft only. It is understood that the motion of the drive shaft shown in FIG. 4 will be utilised to rotate a rotatable device in the manner explained elsewhere within the present disclosure. FIG. 4(a) shows a float device 40 connected to a connecting rod 42. The connecting rod 42 can be manufactured from a metal or another suitable material so as to provide a substantially rigid structure. The connecting rod 42 is in connection with a crank arm 44 which in turn is in connection with drive shaft 46. The connecting rod 42 is attached to the float device 40 and crank arm 44 via hinged joints 48, thereby permitting a certain amount of lateral motion of the float device 40. This arrangement avoids problems associated with repeated flexure of suspending components such as ropes. FIG. 4(b) shows a related embodiment which utilises the same components depicted in FIG. 4(a) together with a counterbalance arm 50. Identical numerals to those used in FIG. 4(a) are used in FIG. 4(b) to depict identical components. The provision of the counterbalance arm 50 enables the suspending rod to always be in tension and hence be in a known state. Additionally, this arrangements permits the addition of inertia to the system which can be used to modify the natural frequency. FIG. 4(c) shows a further variant comprising a float device 40 suspended using a substantially rigid connecting rod 42 coupled via hinges 48 to a crank arm 44. The crank arm 44 is connected to a pivot 52 and to a counterbalance arm 50. The counterbalance arm is in connection with the drive shaft 46, optionally via gearing 54. This arrangement permits the possibility of mechanical magnification of linear motion of the suspending rod, for increased angular velocity of the drive shaft through transmission gearing.

The arrangements shown in U.S. Pat. No. 5,424,582 might be incorporated into the present invention provided that the float means described therein are adjusted so as to have a natural resonant frequency which is substantially resonant with the frequency of the waves.

The invention can provide for acceleration of the generator during both upward and downward motion of the body. This can be arranged by using two freewheels and appropriate gearing. Further details concerning how two arrangements can be combined to provide acceleration during both upward and downward motion of the body can be found in U.S. Pat. No. 5,424,582. Such an arrangement can be used in the context of the present invention provided that resonance of the float device with the waves is achieved.

The structure on which the drive shaft is mounted may be moored or otherwise secured to the sea bed, shore, or to a secured structure such as a rig or jetty. Alternatively, it is possible to use a floating structure on which the drive shaft is mounted.

Another alternative embodiment of the invention uses a rigid suspending component, constrained in a vertical attitude by sliding or rotating bearings during its upwards and downwards motions as the body attached below it rises and falls with the water surface. Upward and/or downward motions could then be utilised for acceleration of the flywheel and generator through a suitable linear to rotary motion converter. In another alternative embodiment still the drive shaft might not be disposed in the horizontal plane. Instead, the drive shaft might be disposed vertically, or intermediate between horizontal and vertical. Appropriate gearing, such as bevel gears, can be used to achieve these configurations.

1. Apparatus for converting the motion of sea waves into a source of useful power output, the device comprising:
a structure having a drift shaft mounted thereon;
a float device connected to said structure and in operative connection with the drive shaft so that vertical motion of the float device drives the drive shaft; and
a rotatable device in operative connection with the drive shaft so that rotation of the drive shaft rotates the rotatable device;
in which the float device has a natural frequency of vertical oscillation which is substantially resonant with the frequency of a sea wave.

2. Apparatus according to claim 1 in which the mass of the float device is adjustable so as to tune the natural frequency of vertical oscillation of the float device to be substantially resonant with the frequency of a sea wave.

3. Apparatus according to claim 2 in which the float device comprises an interior chamber and means for admitting water into the chamber and/or expelling water from the chamber.

4. Apparatus according to claim 1 further comprising a counterweight in operative connection with the float device.

5. Apparatus according to claim 1 in which the rotatable device comprises electricity generating means.

6. Apparatus according to claim 5 further comprising a flywheel in operative connection with the drive shaft so that motion of the float device rotates the flywheel.

7. Apparatus according to claim 1 further comprising clutch means, said clutch means being disposed with respect to the rotatable device so that the rotatable device is rotated by the drive shaft only when the drive shaft is rotating in a predetermined direction.

8. Apparatus according to claim 1 further comprising constraining means adapted to restrict side to side motion of the float device.

9. Apparatus according to claim 1 further comprising at least one gearing system for controlling the transmission of rotational motion to or from the rotatable device.

10. Apparatus according to claim 1 in which the float device is connected to said structure via a device disposed below the level of the float device so that the float device drives the drive shaft during the rising portion of a wave.

11. Apparatus according to claim 1 in which the float device has a natural frequency which is substantially resonant with the frequency of a sea wave of wave height in the range 0.5 to 10 m, preferably in the range 1.0 to 4.0 m, most preferably about 2.0 m.

12. Apparatus according to claim 1 in which the float device has a natural frequency in the range 0.05 to 0.33 Hz.

13. Apparatus according to claim 1 adapted so that, when the natural frequency of vertical oscillation of the float device is substantially resonant with the frequency of a sea wave, the amplitude of oscillation of the float device exceeds the amplitude of oscillation of the sea wave, preferably exceeding the amplitude of oscillation of the sea wave by a factor of two or more.

14. Apparatus according to claim 1 comprising a substantially rigid connecting rod coupled to the float device and permitting the float device to be suspended from said structure.

15. Apparatus according to claim 14 further comprising a crank arm, in which the connecting rod is in operative connection with the drive shaft via the crank arm.

16. Apparatus according to claim 15 further comprising a counterbalance arm.

17. Apparatus according to claim 16 further comprising a pivot, in which:
the crank arm and the counterbalance arm are in connection with the pivot so that movement of the connecting rod causes rotational motion of the counterbalance arm about the pivot; and
the counterbalance arm is in operative connection with the drive shaft so that rotational motion of the counterbalance arm about the pivot rotates the rotatable device.

18. A method of converting the motion of sea waves into a source of useful power output comprising the steps of:
disposing a float device on a body of water so that the float device floats thereon;
allowing the motion of sea waves across the body of water to vertically displace the float device; and,
transmitting power associated with vertical displacement of the float device to a rotatable device so that the vertical displacement of the float device caused by the motion of the sea waves rotates the rotatable device;
in which the natural frequency of vertical oscillation of the float device is substantially resonant with the frequency of the sea waves.

19. A method according to claim 18 in which the wave height of the sea waves is in the range 0.5 to 10 m, preferably in the range 1.0 to 4.0 m, most preferably about 2.0 m.

20. A method according to claim 18 in which the natural frequency of vertical oscillation of the float device is in the range of 0.05 to 0.33 Hz.

21. A method according to claim 18 in which the amplitude of oscillation of the float device exceeds the wave height of the amplitude of oscillation.

22. A method according to claim 21 wherein the amplitude of oscillation of the float device exceeds the amplitude of oscillation of the sea wave by a factor of at least two.

23. A method according to claim 18 further comprising the step of generating electricity from the rotation of the rotatable device.

24. A method according to claim 18 comprising the further sep of adjusting the mass of the float device so as to tune the natural frequency of vertical oscillation of the float device to be substantially resonant with the frequency of the sea waves.

25. A method according to claim 18 wherein a counterweight is operatively connected to the float device, and the natural frequency of the float device is the natural frequency of the float device in connection with the counterweight.

26. A method according to claim 18 in which power is transmitted to the rotatable device through clutch means so that the rotatable device is rotated by the drive shaft only when the float device is vertically displaced in a predetermined direction.
